(19) United States
(12) Patent Application Publication
(10) Pub. No.: US 2010/0034047 A1
(43) Pub. Date: Feb. 11, 2010

(54) MIXING BOWL WITH COLD BAR FOR MIXER

(76) Inventor: William D. Witten, Troy, OH (US)

Correspondence Address: THOMPSON HINE LLP;Intellectual Property Group, P.O Box 8801, DAYTON, OH, 45401-8801, US

(21) Appl. No.: 12/186,820

(22) Filed: Aug. 6, 2008

(51) Int. Cl. A21C 1/00

(52) U.S. Cl. 366/98; 156/73.5; 29/455.1

(57) ABSTRACT

A dough mixer includes a bowl configured to be supported within a cabinet of the dough mixer. The bowl includes a bowl body defining an opening through which dough is inserted into the bowl for a mixing operation. The bowl body includes a front, a back, a first side extending from the front to the back and a second side opposite the first side extending from the front to the back. Each first and second side includes an opening therethrough. An agitator is mounted for rotation within the bowl. A cold bar assembly includes a tubular rod mounted to the first side of the bowl body at a first end and mounted to the second side of the bowl body at a second end opposite the first end. The tubular rod defines a coolant passageway extending therethrough. A sleeve has a bore extending therethrough. An outer open end of the sleeve is mounted about the opening of the first side of the bowl body such that the bore communicates with the opening of the first side of the bowl body and an inner open end of the sleeve receives the first end of the tubular rod within the bore such that coolant can be passed through the opening of the first side of the bowl body and into the coolant passageway.

### TECHNICAL FIELD

This application relates generally to dough mixers and more particularly to a dough mixer including a mixing bowl with refrigerated cold bar.

### BACKGROUND

Bread dough is often mixed at controlled temperatures (e.g., about 78° F. to about 80° F.). During mixing, friction and viscous shear causes temperature to rise in the dough, which can cause the dough to become sticky and difficult to process.

Mixers are known that utilize cooled mixing components to control temperature of the dough during a mixing process. For example, U.S. Pat. No. 4,275,568 discloses a mixing bowl for a mixer that includes flow passages in a sheet panel through which a cooling fluid passes.

### SUMMARY

In an aspect, a dough mixer includes a bowl configured to be supported within a cabinet of the dough mixer. The bowl includes a bowl body defining an opening through which dough is inserted into the bowl for a mixing operation. The bowl body includes a front, a back, a first side extending from the front to the back and a second side opposite the first side extending from the front to the back. Each first and second side includes an opening therethrough. An agitator is mounted for rotation within the bowl. A cold bar assembly includes a tubular rod mounted to the first side of the bowl body at a first end and mounted to the second side of the bowl body at a second end opposite the first end. The tubular rod defines a coolant passageway extending therethrough. A sleeve has a bore extending therethrough. An outer open end of the sleeve is mounted about the opening of the first side of the bowl body such that the bore communicates with the opening of the first side of the bowl body and an inner open end of the sleeve receives the first end of the tubular rod within the bore such that coolant can be passed through the opening of the first side of the bowl body and into the coolant passageway.

In another aspect, a method of installing a refrigerated component in a mixing bowl of a mixer including an agitator rotatably mounted within the mixing bowl is provided. The method includes mounting a sleeve having a bore extending therethrough to a first side of a bowl body of the mixing bowl. The sleeve includes an outer open end mounted about a first opening in the first side of the bowl body such that the bore communicates with the first opening. A first end of a tubular rod is mounted to the first side of the bowl body of the mixing bowl by locating the first end of the tubular rod within an inner open end of the sleeve. A second end of the tubular rod is mounted to a second side of the bowl body of the mixing bowl opposite the first side. The tubular rod defines a coolant passageway extending therethrough such that coolant can be passed through the first opening and into the coolant passageway.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a front view of an embodiment of a mixing machine;

FIG. 2 is a perspective view of a mixing bowl for the mixing machine of FIG. 1 including an embodiment of a refrigerated tubular member assembly;

FIG. 3 is a section view of an attachment for the tubular member assembly of FIG. 2; and

FIG. 4 is a perspective view of the mixing bowl of FIG. 2 including an embodiment of a refrigeration jacket.

### DETAILED DESCRIPTION

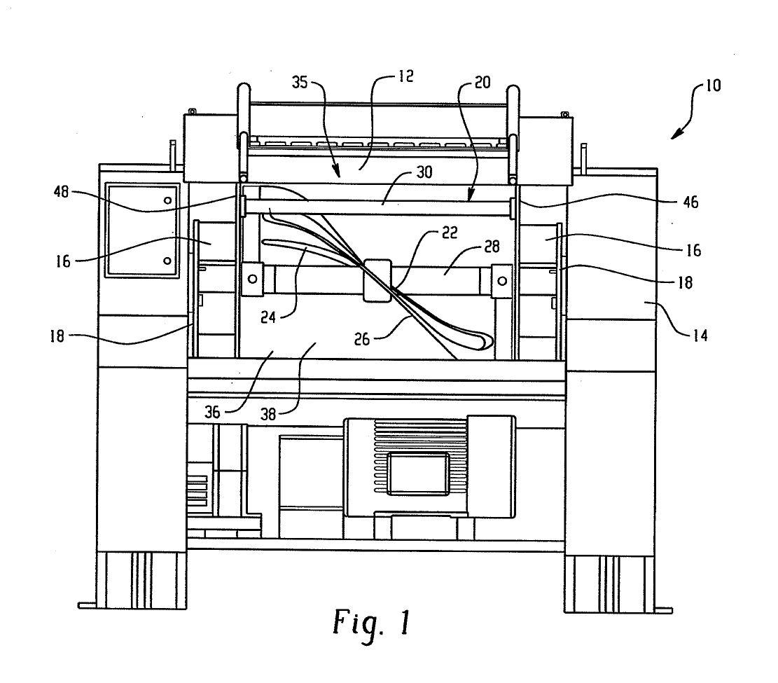

Referring to FIG. 1, a mixer 10 includes a mixing bowl 12 mounted within a cabinet 14. The mixing bowl 12 is an open top 20 arrangement that, in this illustration, is rotated to a sideways position. The mixing bowl 12 is supported at each end by support members 16 that are mounted to a support plate 18. An agitator 22 is rotatably mounted within the mixing bowl 12. The agitator 22 includes a pair of mixing arms 24 and 26 and a rotatable shaft 28 that supports and rotates the mixing arms 24 and 26 during a mixing operation. While agitator 22 is shown by FIG. 1, various agitator assemblies can be utilized including refrigerated agitator assemblies such as that described by U.S. Pat. No. 6,047,558, the details of which are hereby incorporated by reference as if fully set forth herein.

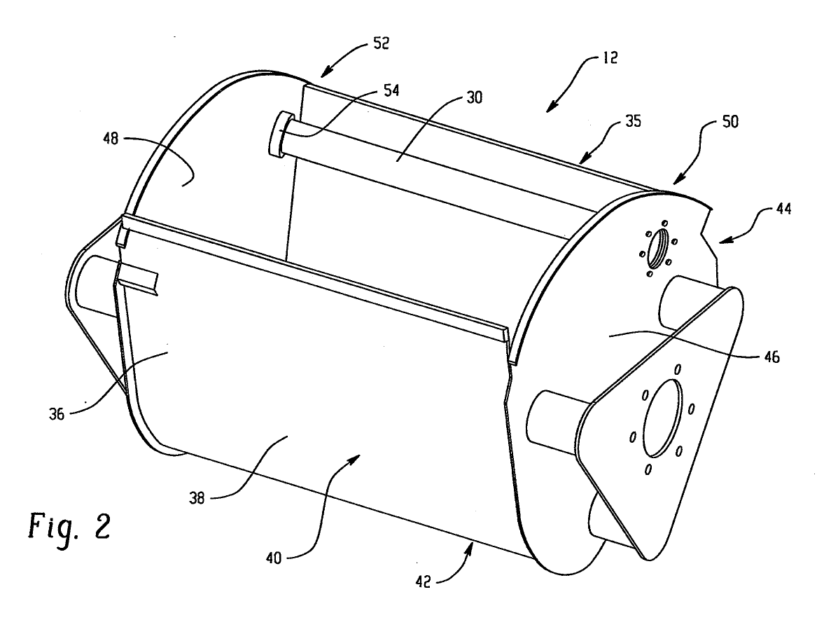

Referring also to FIG. 2, a bowl body 36 includes a U-shaped sheet panel 38 (e.g., formed of stainless steel) that forms a front 40, a bottom 42 and a rear 44 of the mixing bowl 12. Side panels 46 and 48 connect the front 40, bottom 42 and rear 44 of the bowl body 36. The mixing bowl 12 includes cold bar assembly, generally referred to as element 35, that includes a tubular rod 30 that extends from one side panel 46 of the mixing bowl to the opposite side panel 48 of the mixing bowl. As will be described in greater detail below, cold bar assembly 35 including the tubular rod 30 provides a coolant passageway for the passage of coolant, such as cold water or glycol, therethrough to aid in regulating temperature within the mixing bowl 12 during a mixing operation. Such regulation of temperature in the mixing bowl 12 during a mixing operation can control the temperature of the dough during a mixing process.

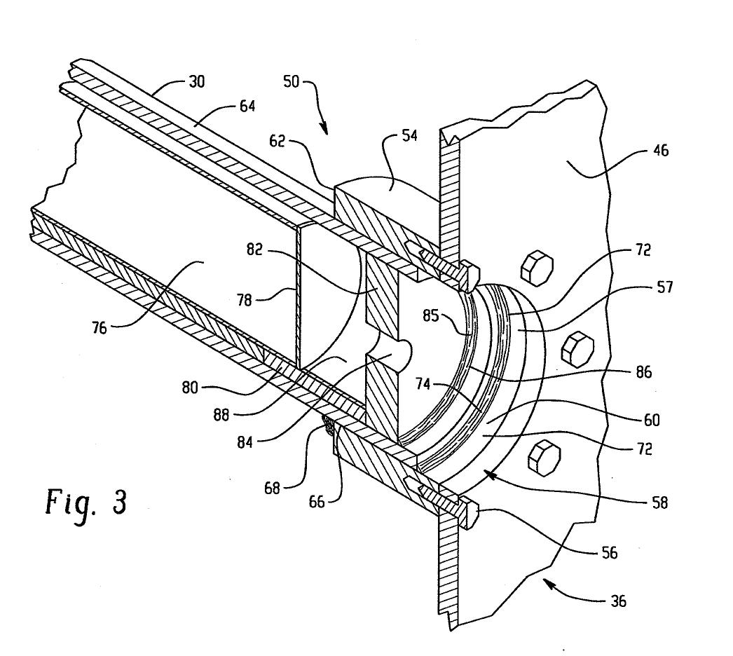

FIG. 3 illustrates a connection of one end 50 of the tubular rod 30 to the bowl body 36. Because an opposite end 52 (see FIG. 2) of the tubular rod 30 is connected in the same manner, only connection of end 50 is described in detail.

A sleeve 54 is mounted (e.g., bolted using fasteners 56) to the side panel 46 such that an outer open end 57 of the sleeve extends about an opening 58 formed in the side panel 46 with a bore 60 of the sleeve in communication with the opening 58. An inner open end 62 of the sleeve 54 receives the end 50 of the tubular rod 30 within the bore 60.

The inner open end 62 of the sleeve 54 extends about a periphery 64 of the tubular rod 30 thereby defining an interface 66 between the sleeve and the periphery of the tubular rod. A weld 68 extends along this interface 66 and about the periphery 64 of the tubular rod 30 forming a fluid tight seal at the interface 66. The end 50 of the tubular rod 30 extends along an inner surface 70 of the sleeve 54 thereby defining an interface 72 between the outer open end 50 and the inner surface of the sleeve. A weld 74 extends along this interface 72 and along the inner surface 70 of the sleeve 54 forming a fluid tight seal at the interface 72.

A tube 76 extends through the tubular rod 30. The tube 76 has capped ends 78 to prevent passage of coolant through the tube and to fill volume within the tubular rod 30. The tube 76 has an outer diameter that is less than an inner diameter of the tubular rod 30 so that the coolant passageway is formed between the tube 76 and the tubular rod 30. Spacers 80 may be used to locate the tube 76 substantially coaxially with the tubular rod 30.

A conduit connecting plate 82 is provided at the outer open end 50 of the tubular rod 30. The conduit connecting plate 82 includes a port 84 to which a conduit (e.g., a hose) directing coolant can be connected. The conduit connecting plate 82 is welded to the tubular rod 30 by a weld 85 extending along an interface 86 between an inner surface 88 of the tubular rod and a periphery of the conduit connecting plate. The weld 85 forms a fluid tight seal between the conduit connecting plate 82 and the tubular rod 30.

Referring back to FIG. 2, each end 50 and 52 is connected to the mixing bowl 12 in the manner described above. However, one end 50 is an inlet end where coolant enters the tubular rod 30 and the opposite end 52 is an outlet end where coolant exits the tubular rod.

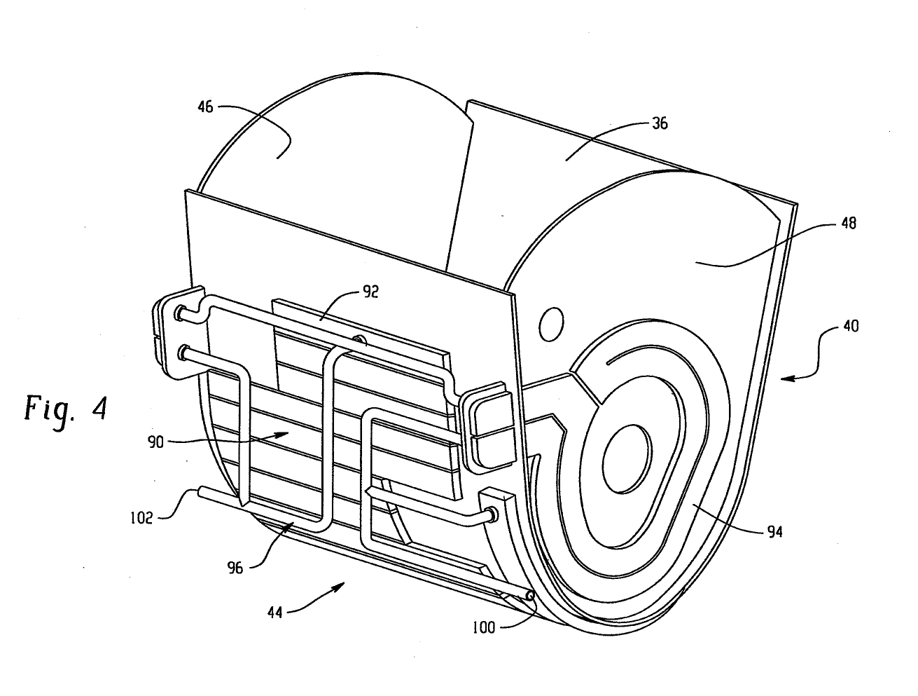

Referring now to FIG. 4, the tubular rod 30 (not shown) may be used along with a refrigeration jacket 90 located on the bowl body 36, which is formed by a plurality of channel members 92 (e.g., formed of stainless steel). The channel members 92 provide flow passages through which the coolant can travel in order to control or maintain a temperature within the mixing bowl 12 during a mixing operation.

The refrigeration jacket 90 extends from the front 40 of the bowl body 36 to the rear 44 of the bowl body. Side channel members 94 are also provided on each of the side panels 46 and 48 so that coolant can also flow along the sides of the bowl body 36. A coolant passage assembly 96 connects the refrigeration jacket 90 to a coolant source (see inlet 100) and also provides an outlet 102 for the coolant exiting the refrigeration jacket. The coolant passage assembly 96 also connects the side channel members 94 to the coolant source. Additional details of the refrigeration jacket 90 can be found in pending U.S. patent application Ser. No. ______ [attorney docket number 074743-00005], filed on the same day as the instant application, entitled “Dough Mixer and Mixing Bowl with Refrigeration Jacket”, the details of which are hereby incorporated by reference as if fully set forth herein.

The coolant passage assembly 96 is also used to deliver coolant to the tubular member 30. In some embodiments, the coolant passage assembly 96 is connected directly to the tubular member 30 by connecting the coolant passage assembly to the port 84 formed in the conduit connecting plate 82. In another embodiment, the coolant may be routed first through the refrigeration jacket 90 and then to the tubular member 30.

The above-described tubular member assembly provides a number of advantages. The tubular member 30 can be attached or installed on site, for example, after the mixer 10 is delivered. The tubular member 30 can replace a breaker bar with no refrigeration with a refrigerated bar. Any suitable material(s) can be used to form the tubular member assembly, such as stainless steel.

It is to be clearly understood that the above description is intended by way of illustration and example only and is not intended to be taken by way of limitation, and that changes and modifications are possible. Accordingly, other embodiments are contemplated and modifications and changes could be made without departing from the scope of this application.

What is claimed is:

1. A dough mixer, comprising:
a bowl configured to be supported within a cabinet of the dough mixer, the bowl comprising a bowl body defining an opening through which dough is inserted into the bowl for a mixing operation, the bowl body including a front, a back, a first side extending from the front to the back and a second side opposite the first side extending from the front to the back, each first and second side including an opening therethrough;
an agitator mounted for rotation within the bowl; and
a cold bar assembly including:
a tubular rod mounted to the first side of the bowl body at a first end and mounted to the second side of the bowl body at a second end opposite the first end, the tubular rod defining a coolant passageway extending therethrough; and
a sleeve having a bore extending therethrough, an outer open end of the sleeve mounted about the opening of the first side of the bowl body such that the bore communicates with the opening of the first side of the bowl body and an inner open end of the sleeve receiving the first end of the tubular rod within the bore such that coolant can be passed through the opening of the first side of the bowl body and into the coolant passageway.

2. The dough mixer of claim 1, wherein the inner end of the sleeve extends about a periphery of the tubular rod thereby defining an interface between the sleeve and the periphery of the tubular rod, a weld extending along the interface.

3. The dough mixer of claim 2, wherein the sleeve is a first sleeve, the cold bar assembly comprising a second sleeve having a bore extending therethrough, an outer open end of the second sleeve mounted about the opening of the second side of the bowl body such that the bore communicates with the opening of the second side of the bowl body and an inner open end of the second sleeve receives the second end of the tubular rod within the bore such that coolant can be passed from the coolant passageway through the opening of the second side of the bowl body.

4. The dough mixer of claim 3, wherein the inner open end of the second sleeve extends about a periphery of the tubular rod thereby defining an interface between the second sleeve and the periphery of the tubular rod, a weld extends along the interface between the second sleeve and the periphery of the tubular rod.

5. The dough mixer of claim 2, wherein the first end of the tubular rod extends along an inner surface of the sleeve thereby defining an interface between the first end of the tubular rod and the inner surface of the sleeve, a weld extends along the interface between the first end of the tubular rod and the inner surface of the sleeve.

6. The dough mixer of claim 1 further comprising a plurality of fasteners extending through the first side of the bowl body and into an end face of the sleeve thereby fastening one end of the cold bar assembly to the bowl body without welding.

7. The dough mixer of claim 1 further comprising a tube located within the tubular rod occupying space therein, the coolant passageway defined between the tube and the tubular rod, each end of the tube being closed such that coolant does not enter the tube.

8. The dough mixer of claim 1, wherein the cold bar assembly comprises a connecting plate welded to an inner surface of the tubular rod at a location within the sleeve, the connecting plate including a port extending therethrough to which a coolant conduit can be connected.

9. The dough mixer of claim 8, wherein the sleeve is a first sleeve and the connecting plate is a first connecting plate, the cold bar assembly comprising
a second sleeve having a bore extending therethrough, an outer open end of the second sleeve mounted about the opening of the second side of the bowl body such that the bore communicates with the opening of the second side of the bowl body and an inner open end of the second sleeve receives the second end of the tubular rod within the bore such that coolant can be passed from the coolant passageway through the opening of the second side of the bowl body; and
a second connecting plate welded to an inner surface of the tubular rod at a location within the second sleeve, the second connecting plate including a port extending therethrough to which a coolant conduit can be connected;
wherein, the first connecting plate is welded to the inner surface of the tubular rod at a location spaced inwardly from the outer end of the first sleeve and the second connecting plate is welded to the inner surface of the tubular rod at a location spaced inwardly from the outer end of the second sleeve.

10. The dough mixer of claim 9, wherein, during use, coolant is introduced into the coolant passageway at the port extending through the first connecting plate, the port extending through the first connecting plate being spaced inwardly from the outer end of the first sleeve, the coolant exiting the coolant passageway at the port extending through the second connecting plate, the port of the second connecting plate being spaced inwardly from the outer end of the second sleeve.

11. The dough mixer of claim 1 further comprising a coolant supply assembly that supplies coolant to the coolant passageway.

12. A method of installing a refrigerated component in a mixing bowl of a mixer including an agitator rotatably mounted within the mixing bowl, the method comprising:
(a) mounting a sleeve having a bore extending therethrough to a first side of a bowl body of the mixing bowl, the sleeve including an outer open end mounted about a first opening in the first side of the bowl body such that the bore communicates with the first opening;
(b) mounting a first end of a tubular rod to the first side of the bowl body of the mixing bowl by locating the first end of the tubular rod within an inner open end of the sleeve; and
(c) mounting a second end of the tubular rod to a second side of the bowl body of the mixing bowl opposite the first side, the tubular rod defining a coolant passageway extending therethrough such that coolant can be passed through the first opening and into the coolant passageway.

13. The method of claim 12, wherein step (b) includes welding along an interface between the sleeve and a periphery of the tubular rod, the interface formed at the inner end of the sleeve extending about the periphery of the tubular rod.

14. The method of claim 13, wherein the sleeve is a first sleeve, the method further comprising mounting a second sleeve having a bore extending therethrough to a second side of a bowl body of the mixing bowl, the second sleeve including an outer open end mounted about a second opening in the second side of the bowl body such that the bore of the second sleeve communicates with the second opening.

15. The method of claim 14, wherein step (c) includes welding along an interface between the second sleeve and a periphery of the tubular rod, the interface formed at the inner end of the second sleeve extending about the periphery of the tubular rod.

16. The method of claim 13 further comprising fastening the sleeve to the first side of the bowl body using a plurality of fasteners extending through the first side of the bowl body and into the outer end of the sleeve.

17. The method of claim 13 further comprising welding along an interface between the first end of the tubular rod and an inner surface of the sleeve.

18. The method of claim 12 further comprising providing a tube within the tubular rod occupying space therein, the coolant passageway defined between the tube and the tubular rod, each end of the tube being closed such that coolant does not enter the tube.

19. The method of claim 12 further comprising welding a connecting plate to an inner surface of the tubular rod, the connecting plate including a port extending therethrough to which a coolant conduit can be connected.

20. The method of claim 12 further comprising supplying a coolant to the coolant passageway.
